(19) United States
(12) Patent Application Publication
(10) Pub. No.: US 2023/0000102 A1
(43) Pub. Date: Jan. 5, 2023

(54) CONFECTIONERY ASSEMBLY

(71) Applicant: humangear, Inc., San Francisco, CA (US)

(72) Inventor: Christopher A. MIKSOVSKY, Bend, OR (US)

(21) Appl. No.: 17/734,806

(22) Filed: May 2, 2022

Related U.S. Application Data
(60) Provisional application No. 63/216,665, filed on Jun. 30, 2021.

(51) Int. Cl. A23G 3/54

(52) U.S. Cl. CPC A23G 3/54

(57) ABSTRACT

A confectionary kit that holds ingredients suitable for making s'mores is described. In some embodiments, the kit takes the form of a box that holds two marshmallows positioned side-by-side and a stack that contains four crackers or biscuits and one or more chocolate pieces. In other embodiments, additional marshmallows and stacks are provided.

### CROSS-REFERENCE TO RELATED APPLICATIONS

This application claims priority of U.S. Provisional Application No. 63/216,665, filed on Jun. 30, 2021, which is incorporated herein by reference in its entirety.

### FIELD

The invention relates generally to the field of confectionery items, and more particularly to a confectionery assembly more suited to purchase, storage, and transport for use in the outdoors or when traveling.

### BACKGROUND

For many people, meals and eating in general are fundamental to the enjoyment of the outdoors. This could be a meal cooked over a campfire when backpacking, a snack on a hike, eating food at a picnic in the local park, or otherwise when outside and on the go.

While eating outdoors, many people enjoy desserts and sweet treats. One iconic dessert typically associated with the outdoors is a confectionery assembly consisting of a layered “sandwich” typically made by two outer graham crackers above and below, a layer of chocolate, and a layer or toasted, browned or otherwise warmed puffed sugary confection such as a marshmallow in-between the graham crackers and next to the chocolate. This confectionery assembly is commonly known as a “s'more.” In typical practice, a person warms one or more marshmallows using a stick or rod over the coals or flames of a fire, grill, stove, or other heat source. This warming softens the marshmallow considerably and can brown or caramelize the exterior. One or more pieces of chocolate are placed atop an appreciably flat cookie or biscuit such as a graham cracker. The toasted marshmallow is then placed on top of the piece or pieces of chocolate. A second cookie, biscuit, or graham cracker is then placed on top of the marshmallow (the stick or rod can be easily removed at this point by pulling gently). The warmed and/or browned marshmallow transfers some of its stored heat onto the chocolate which can soften or melt the chocolate somewhat. This layered assembly—graham cracker, chocolate, marshmallow, graham cracker—is then eaten and enjoyed. The process may be, and often is, repeated for additional s'mores and associated enjoyment. An alternate process is to assemble the s'more with the aforementioned layers, wrap the entire assembly in metal tin foil, and then place the assembly in or near a heat source to warm up. After the assembly is warmed up, the tin foil is removed and the s'more is eaten and enjoyed.

While the final s'more is a desired and delicious sweet treat, there are some challenges with bringing it into fruition. Some of these challenges are as follows:

Component purchase: The user is typically required to purchase the components separately. While there are often outdoor and camping meals sold in stores that cater to outdoor activities, typically these stores do not stock the components required to make a s'more. Thus, in general practice the user must travel to a grocery store that sells the individual s'more items.

Larger than desired quantities: Marshmallows are generally sold in bags of larger quantities (e.g. 40 or 50 marshmallows), graham crackers are often sold in boxes of larger quantities (e.g. a box containing 30 graham crackers), and chocolate is often sold in larger bars. Even though a user may only desire to make a small number of s'mores on a trip, they typically must purchase the above larger quantities and then separate and re-package the smaller number of components they may need.

Transport: The user must figure out a means to safely transport the s'more components. The marshmallows are soft and compressible, and can be somewhat sticky, so typically they must be packed in a way to prevent crushing or sticking to other food items. Typical graham crackers are somewhat delicate and can be easily cracked, chipped, or broken. The user must preferably pack these in a way to keep them intact. Lastly, the chocolate pieces are subject to melting if taken outside into warmer weather, so the user ideally packs these separately so any melted chocolate will not escape from the packaging and get onto other food or non-food items.

Leftover components: Many people will only have the time or means to travel in the outdoors a small number of times each year. For example, a person may make one or two weekend backpacking trips where they may desire to have some s'mores. A typical person might enjoy 1˜2 s'mores/night. So, for this person they may only require a small number of total s'mores—perhaps 10 s'mores or less per year. However, as previously mentioned, the s'more components are most typically sold in larger quantities e.g. bags of 50 marshmallows, boxes of 30 graham crackers, etc. But if a user only needs to make a far smaller number of s'mores then they are left with leftover marshmallows, graham crackers, and chocolate. These can be stored for some time, but eventually the partially opened packages of marshmallows, graham crackers, and chocolate can and will go stale. For many people, items like marshmallows and graham crackers are only eaten in the outdoors and are rarely if ever eaten at home. Moreover, an open bag of marshmallows will typically slowly congeal into a large, sticky mass of marshmallows that are not as easily separated and used. In common experience, users will often be forced to discard partially-open larger packages of marshmallows, graham crackers, and chocolate that have gone stale or degraded in quality, which is expensive and wasteful. And when the user wants to make s'mores again they are often required to restart the entire process over—travelling to a grocery store, purchasing the bulk packages of the various components, repackaging them for their trip, etc.

As a consequence there is a need for a more convenient way to purchase and transport s'more components for ready enjoyment in the outdoors and otherwise.

### SUMMARY

There is disclosed in this application a confectionery assembly for a “s'more” which avoids the disadvantages of current s'more component options, while affording additional structural and convenience advantages in one, integrated solution.

In particular, there is disclosed a confectionery assembly comprising: a stack of graham crackers, one or more pieces of chocolate (which may be subdivided), and two or more marshmallows. The relative geometry of each component is carefully selected such that a very compact arrangement of the components is possible. The components are then placed in this compact configuration into a semi-rigid packaging box or container that protects the components from damage.

### BRIEF DESCRIPTION OF THE DRAWINGS

The invention and the advantages thereof, may best be understood by reference to the following description taken in conjunction with the accompanying drawings in which:

FIG. 1 is a perspective view of a typical, generally cylindrical marshmallow. This view shows the following dimensions (M is for Marshmallow):
Mh: Marshmallow height
Md: Marshmallow diameter

FIG. 2 is a perspective view of a small chocolate bar. This view shows the following dimensions (B is for Bar):
Bx: Chocolate bar dimension in the x-axis, or the width
By: Chocolate bar dimension in the y-axis, or the length
Bz: Chocolate bar dimension in the z-axis, or the height or thickness

FIG. 3 is a perspective view of a graham cracker cookie, biscuit. This view shows the following dimensions (C is for Cracker):
Cx: Cracker dimension in the x-axis, or the width
Cy: Cracker dimension in the y-axis, or the length
Cz: Cracker dimension in the z-axis, or the height or thickness

FIG. 4 is a perspective view of a confectionery assembly in accordance with one embodiment.

FIG. 5 is a top view of the confectionery assembly shown in FIG. 4.

FIG. 6 is a front view of the confectionery assembly shown in FIG. 4.

FIG. 7 is a right side view of the confectionery assembly shown in FIG. 4.

FIG. 8 is a perspective view of a second embodiment of a confectionery assembly.

FIG. 9 is a top view of an alternate embodiment of the confectionery assembly shown in FIG. 8.

FIG. 10 is a right side view of an alternate embodiment of the confectionery assembly shown in FIG. 8.

FIG. 11 is a perspective view of a non-circular, generally rectilinear marshmallow. This view shows the following dimensions (M is for Marshmallow):
Mx: Marshmallow dimension in the x-axis, or the width
My: Marshmallow dimension in the y-axis, or the length
Mz: Marshmallow dimension in the z-axis, or the height or thickness

FIG. 12 is a perspective view of a third embodiment of a confectionery assembly using rectilinear marshmallows.

FIG. 13 is a top view of the confectionery assembly shown in FIG. 12.

FIG. 14 is a right side view of the confectionery assembly shown in FIG. 12.

FIG. 15 is a perspective view of a generally elliptical marshmallow.

FIG. 16 is a perspective view of a fourth embodiment of a confectionery assembly using elliptical marshmallows.

FIG. 17 is a perspective view of a fifth embodiment of a confectionery assembly using multiple confectionery sub-assemblies.

FIG. 18 is a perspective view of the confectionery assembly of FIG. 4 packaged in a containing box (showing the box open).

FIG. 19 is a perspective view of the confectionery assembly of FIG. 12 packaged in a containing box (showing the box open).

FIG. 20 is a perspective view of the confectionery assembly of FIG. 16 packaged in a containing box (showing the box open).

FIG. 21 is a perspective view of the confectionery assembly of FIG. 8 packaged in a containing box (showing the box open).

FIG. 22 is a perspective view of the multiple confectionery assemblies of FIG. 17 packaged in a containing box (showing the box open).

### DETAILED DESCRIPTION

For a better understanding of the invention as well as other objects and further features thereof, reference is made to the following detailed description to be read in conjunction with the accompanying drawings wherein:

FIG. 1 is a perspective view of a typical, generally-cylindrical marshmallow 20. Shown here are the rounded surface 22, one of two appreciably flat faces 24, and the following dimensions:
Mh: Marshmallow height
Md: Marshmallow diameter

FIG. 2 is a perspective view of a chocolate bar 30. There may be one or more of the chocolate bars in the confectionery assembly 10. If there is only one chocolate bar 30 it may be readily split into two or more pieces along one or more fracture features 32 that are molded into the chocolate bar 30. Shown here are also the following dimensions:
Bx: Chocolate bar dimension in the x-axis, or the width
By: Chocolate bar dimension in the y-axis, or the length
Bz: Chocolate bar dimension in the z-axis, or the height or thickness

FIG. 3 is a perspective view of a graham cracker 40. While a graham cracker 40 is the preferred embodiment, a cookie, biscuit or other appreciably flat baked good may also be used. Shown here are the width face 42, length face 44, and the following dimensions:
Cx: Cracker dimension in the x-axis, or the width
Cy: Cracker dimension in the y-axis, or the length
Cz: Cracker dimension in the z-axis, or the height or thickness

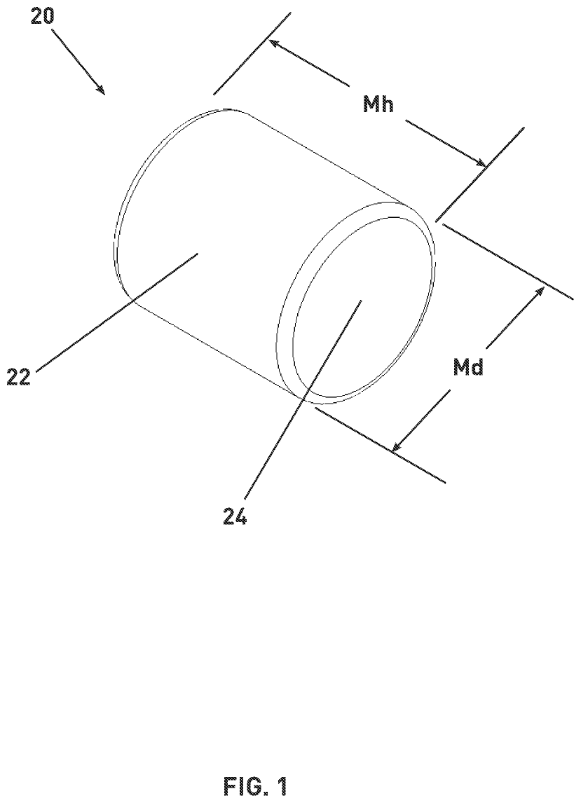

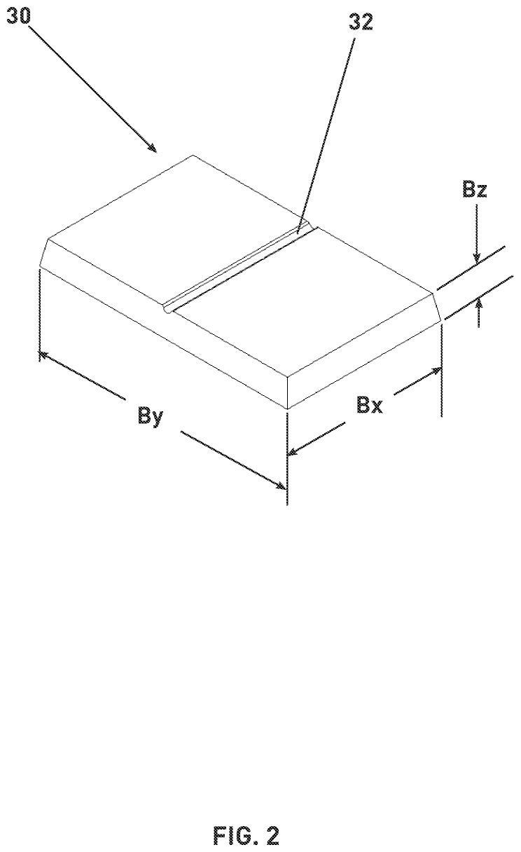

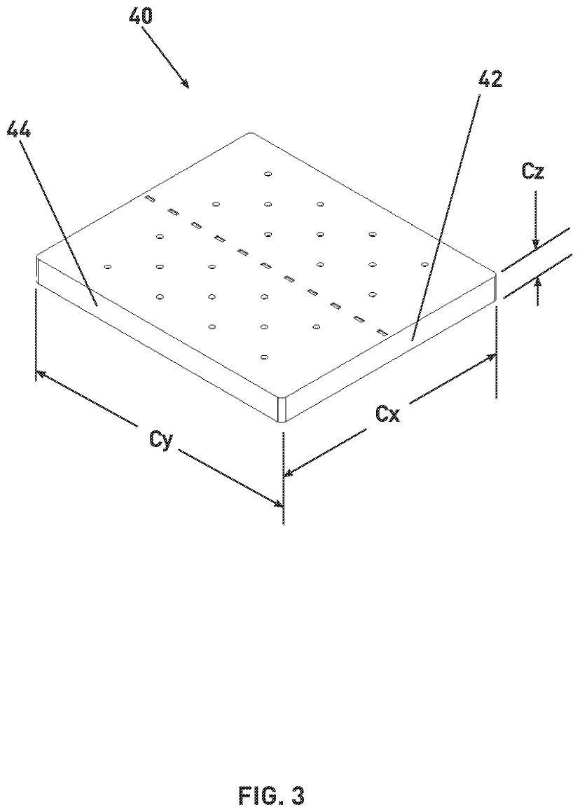

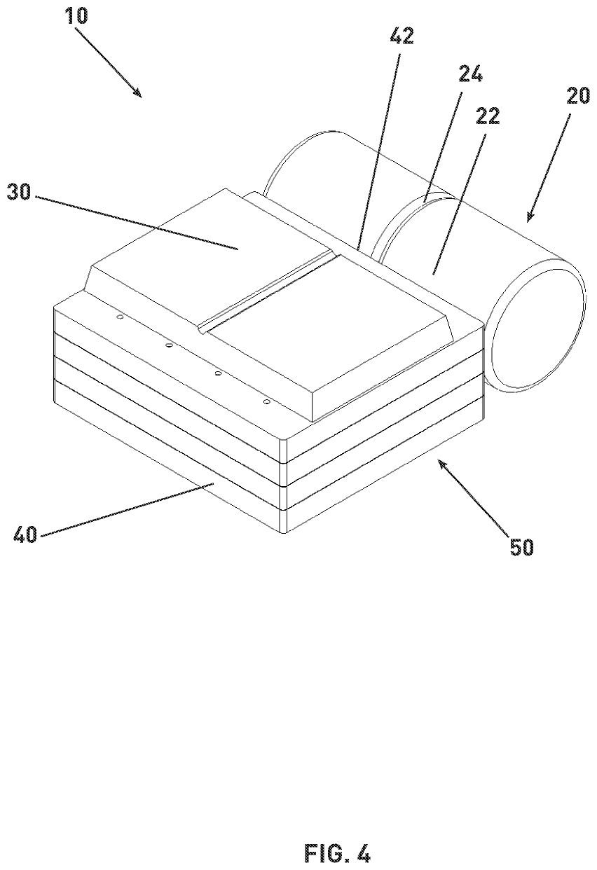

FIG. 4 is a perspective view of a confectionery assembly 10 constructed in accordance with the invention and arranged as shown. The confectionery assembly 10 features two or more generally cylindrical marshmallows 20, one or more chocolate bars 30, and two or more—preferably four—graham crackers 40, which are arrayed in a stack of crackers 50. In this embodiment the marshmallows 20 are positioned with one of their flat ends 24 touching a flat end of the other marshmallow 20, and the rounded surface 22 of each marshmallow 20 touching one or more of the length faces 44 of the stack 50 of graham crackers 40, Note furthermore that in this embodiment the geometry of the relative components has been sized such that the diameter of the marshmallow Md is approximately the same as the total height of the stack of crackers 50 (4*Cz) plus the chocolate bar thickness Bz. Additionally, the marshmallow height Mh is roughly ½ either the cracker width Cx or cracker length Cy. The width and length of the chocolate bar 30 is proportioned to be less than or equal to the width and length of the graham cracker 40. Described as a mathematical formula the geometries of the relative components in this embodiment are as follows:
a) [Mh≈(0.5*Cx)] OR [Mh≈(0.5*Cy)]
   AND
b) Md≈[(4*Cz)+Bz]
   AND
c) (Bx<=Cx) AND (By<=Cy)

By way of example, in the preferred embodiment of the confectionery assembly 10 the geometries of the relative components would be preferably sized as follows (all dimension millimeters):

Marshmallow diameter Md: 28
Marshmallow height Mh: 32
Graham cracker width Cx: 56
Graham cracker length Cy: 64
Graham cracker height Cz: 5.5
Chocolate bar width Bx: 40
Chocolate bar length By: 63
Chocolate bar height Bz: 6.0

It may be appreciated from the above formulas and example that sizing the geometries accordingly creates an extremely compact arrangement of the components with little empty space leftover. Moreover, it can be appreciated that the juxtaposition of the soft, compliant marshmallows directly next to the frangible graham crackers creates transport advantages to the extent the marshmallows act effectively as resilient bodies akin to foamed packing “peanuts” or tissue paper that can help absorb shock and vibration and therefore help to maintain the structural integrity of the graham crackers.

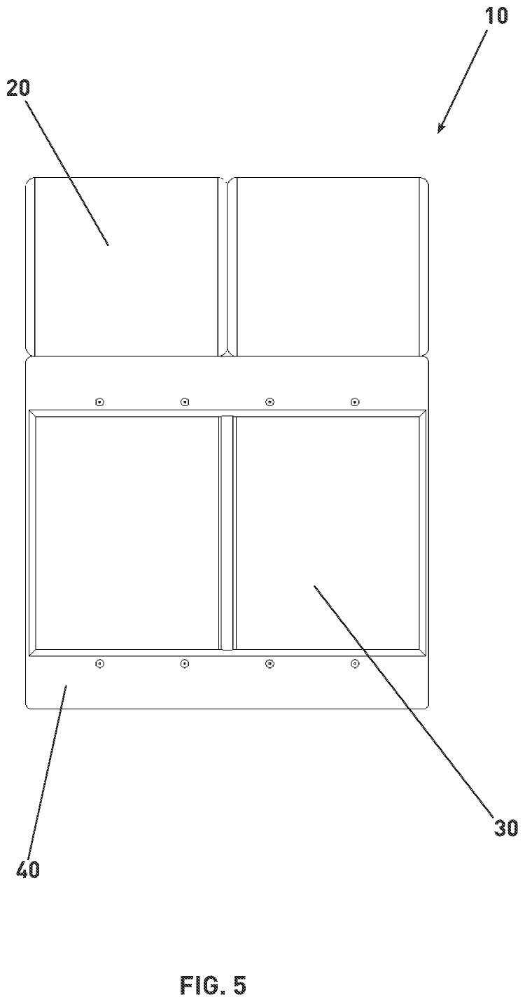

FIG. 5 is a top view of a confectionery assembly 10 shown in FIG. 4.

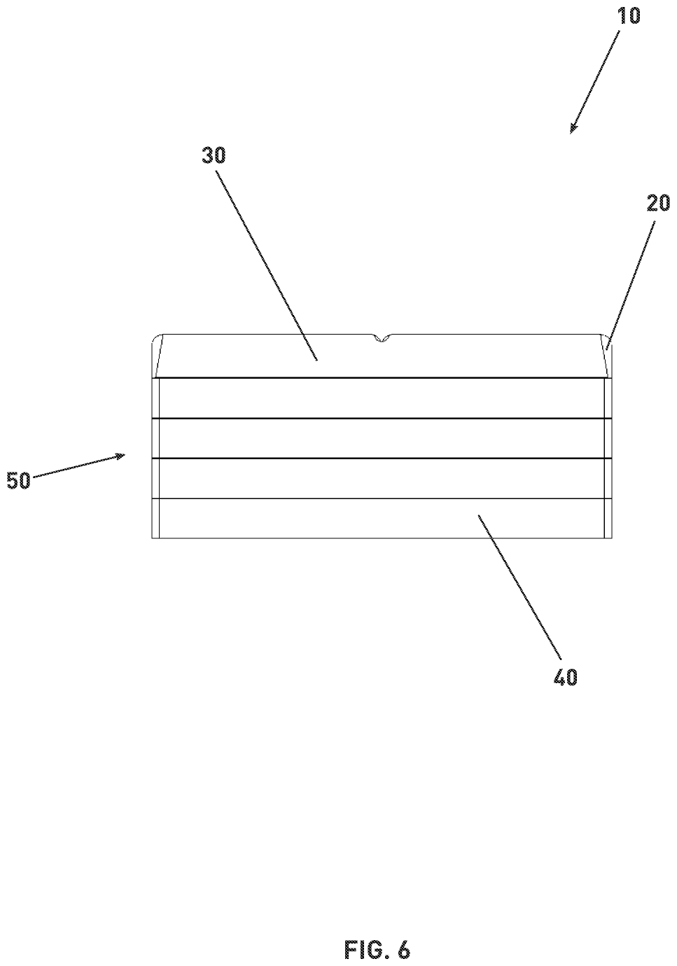

FIG. 6 is a front view of a confectionery assembly 10 shown in FIG. 4.

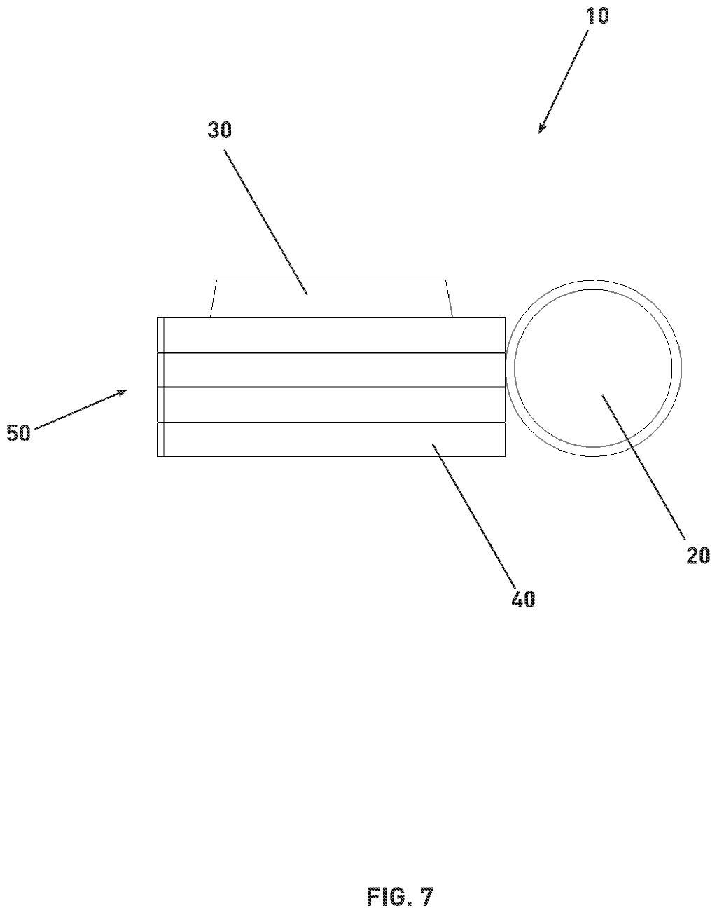

FIG. 7 is a right side view of a confectionery assembly 10 shown in FIG. 4.

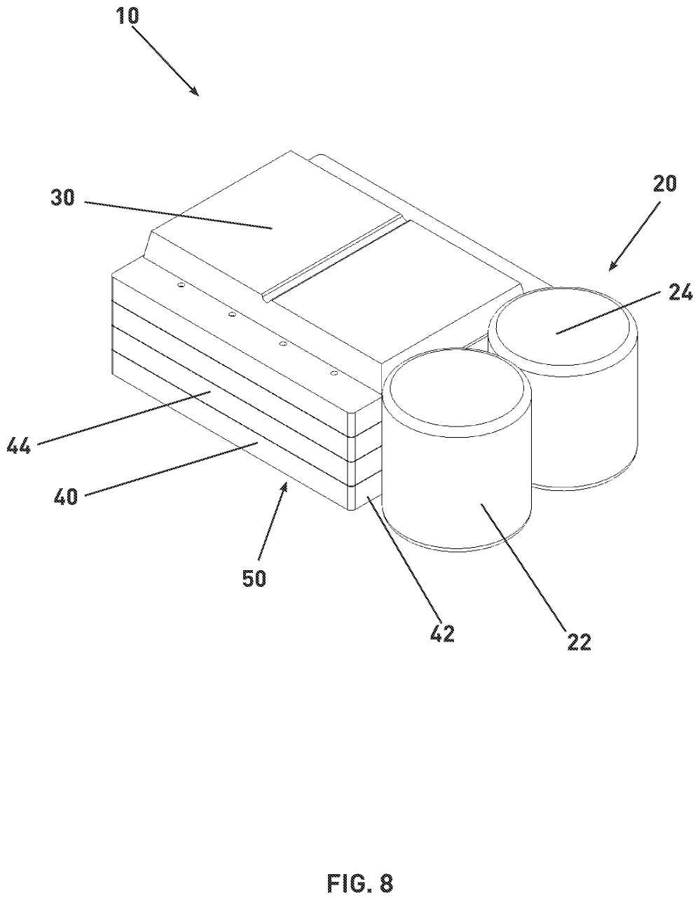

FIG. 8 is a perspective view of an alternate embodiment of the confectionery assembly 10 constructed in accordance with the invention and arranged as shown. The confectionery assembly 10 features two or more marshmallows 20 with their round surfaces 22 touching each other as well as touching either the width face 42 or length face 44 of one or more graham crackers 40 assembled into a stack of crackers 50. Additional there is shown one or more chocolate bars 30, and two or more—preferably four—graham crackers 40, which are arrayed in a stack of crackers 50. Note that in this embodiment the geometry of the relative components has been sized such that the height of the marshmallow Mh is approximately the same as the total height of the stack of crackers 50 (4*Cz) plus the chocolate bar thickness Bz. Additionally, the marshmallow diameter Md is roughly ½ either the cracker width Cx or cracker length Cy. The width and length of the chocolate bar 30 is proportioned to be less than or equal to the width and length of the graham cracker 40. Described as a mathematical formula the geometries of the relative components in this embodiment are as follows:
a) [Md≈(0.5*Cx)] OR [Md≈(0.5*Cy)]
   AND
b) Mh≈[(4*Cz)+Bz]
   AND
c) (Bx<=Cx) AND (By<=Cy)

By way of example, in this alternate embodiment of the confectionery assembly 10 the geometries of the relative components would be preferably sizes as follows (all dimension millimeters):

Marshmallow diameter Md: 28
Marshmallow height Mh: 28
Graham cracker width Cx: 56
Graham cracker length Cy: 64
Graham cracker height Cz: 5.5
Chocolate bar width Bx: 40
Chocolate bar length By: 63
Chocolate bar height Bz: 6.0

Note again juxtaposition of the marshmallows directly next to the graham crackers to help cushion the graham crackers from shocks and vibrations during transport which might otherwise cause the crackers to break or crack.

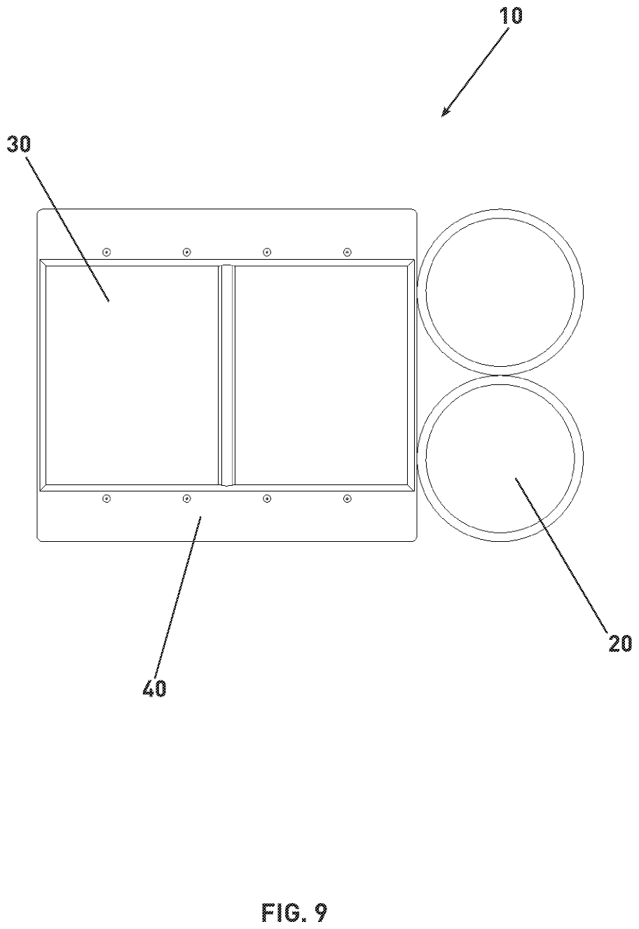

FIG. 9 is a top view of the alternate embodiment of a confectionery assembly 10 shown in FIG. 8.

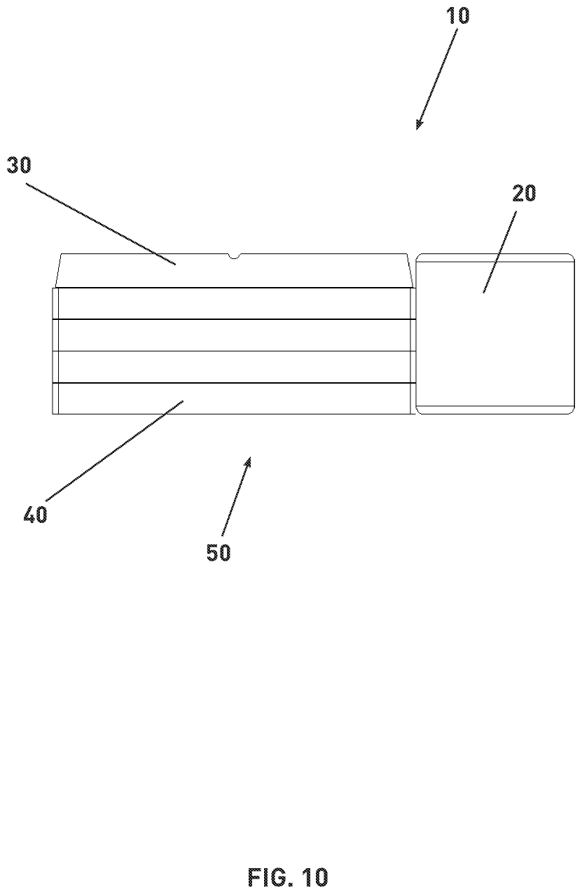

FIG. 10 is a right side view of the alternate embodiment of a confectionery assembly 10 shown in FIG. 8.

FIG. 11 is a perspective view of a non-cylindrical or rectilinear marshmallow 60. This view shows the following dimensions:
Mx: Marshmallow dimension in the x-axis, or the width
My: Marshmallow dimension in the y-axis, or the length
Mz: Marshmallow dimension in the z-axis, or the height or thickness

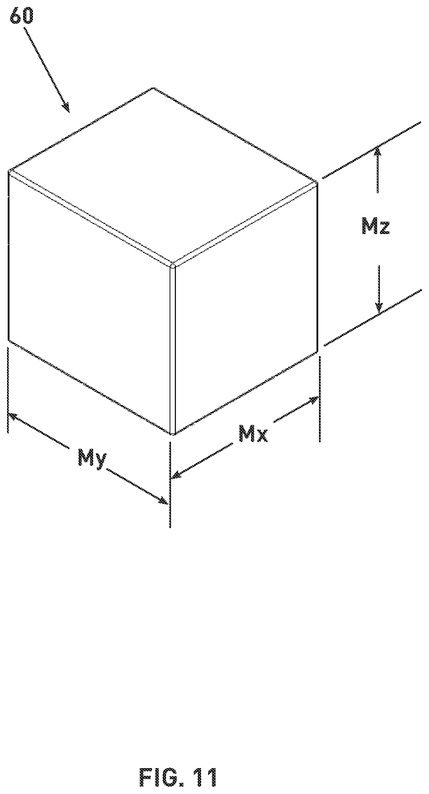

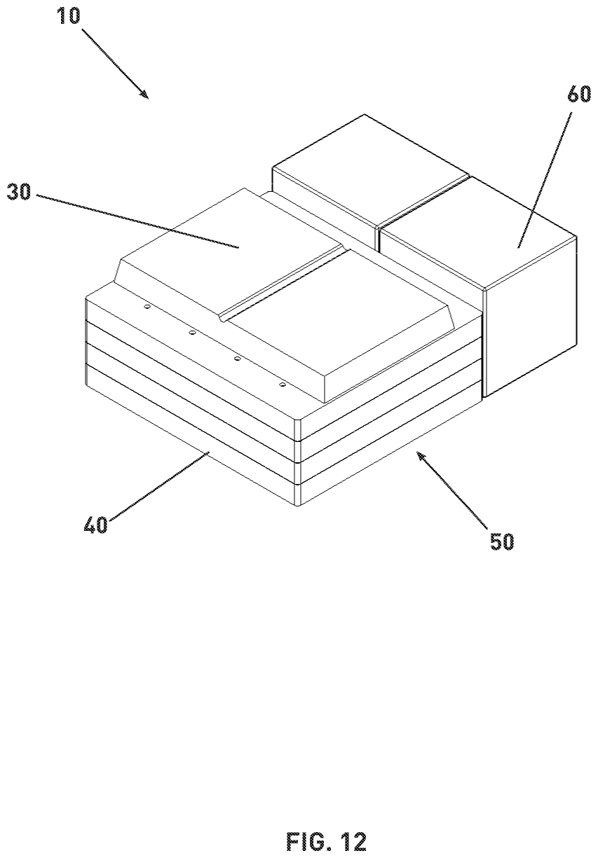

FIG. 12 is a perspective view of an alternate embodiment of the confectionery assembly 10 constructed in accordance with the invention and arranged as shown. The confectionery assembly 10 features two or more non-cylindrical or generally rectilinear marshmallows 60 placed along either the width face 42 or length face 44 of one or more—preferably four—graham crackers 40 arranged into a stack of crackers 50, and one or more chocolate bars 30 resting above, below, or in the middle of the stack 50. Note that in this embodiment the geometry of the relative components has been sized such that the height of the marshmallow Mz is approximately the same as the total height of the stack of crackers 50 plus the chocolate bar thickness Bz. Additionally, the marshmallow width Mx or length My is roughly ½ either the cracker width Cx or cracker length Cy. The width and length of the chocolate bar 30 is proportioned to be less than or equal to the width and length of the graham cracker 40. Described as a mathematical formula the geometries of the relative components in this embodiment are as follows:
a) [Mx≈(0.5*Cx)] OR [My≈(0.5*Cy)]
   AND
b) Mz≈[(4*Cz)+Bz]
   AND
c) (Bx<=Cx) AND (By<=Cy)

By way of example, in this alternate embodiment of the confectionery assembly 10 the geometries of the relative components would be preferably sized as follows (all dimension millimeters):

Marshmallow width Mx: 28
Marshmallow length My: 32
Marshmallow height Mz: 28
Graham cracker width Cx: 56
Graham cracker length Cy: 64
Graham cracker height Cz: 5.5
Chocolate bar width Bx: 40
Chocolate bar length By: 63
Chocolate bar height Bz: 6.0

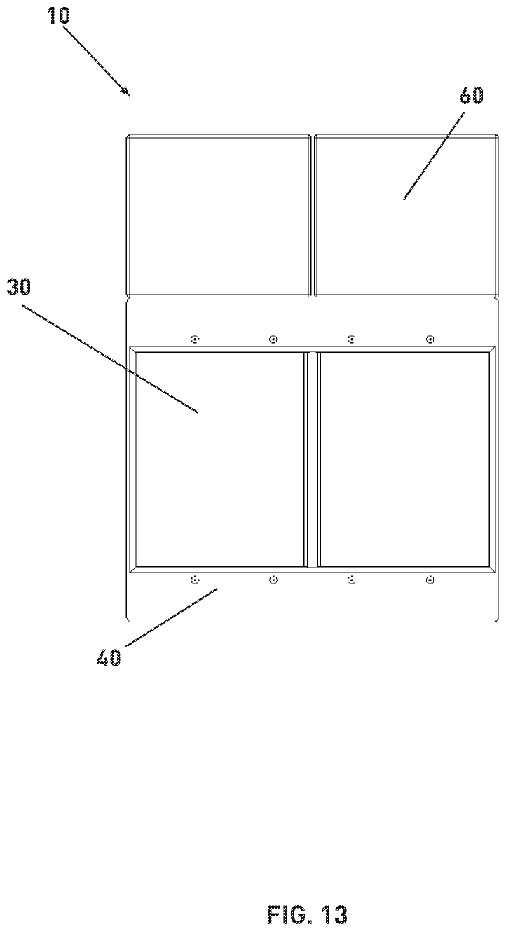

FIG. 13 is a top view of the confectionery assembly 10 shown in FIG. 12.

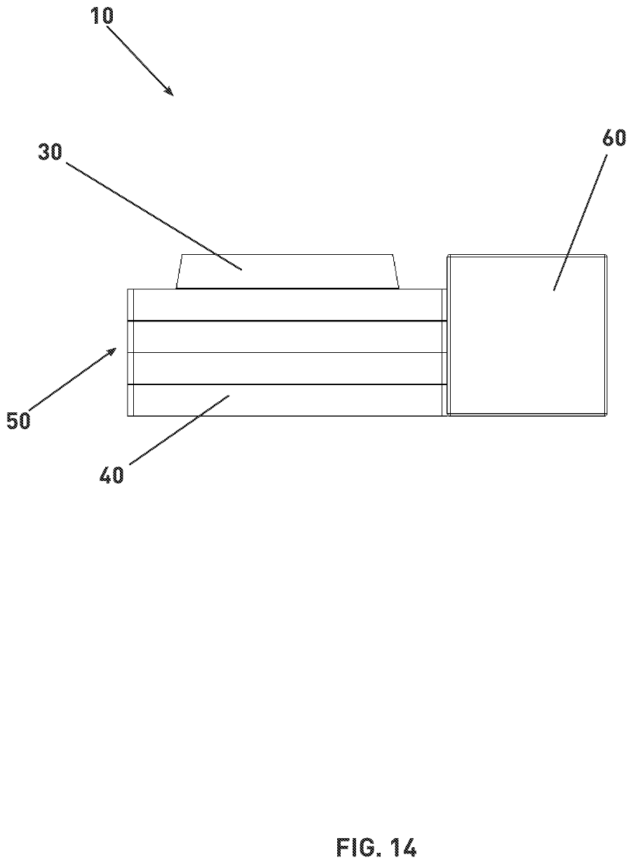

FIG. 14 is a right side view of the confectionery assembly 10 shown in FIG. 12.

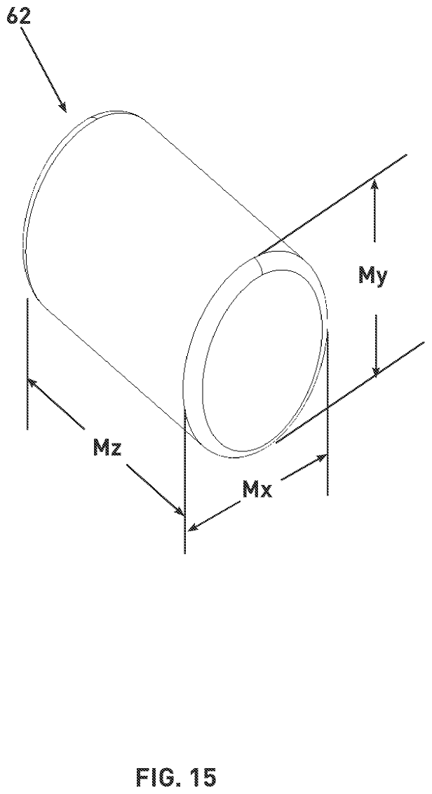

FIG. 15 is a perspective view of an elliptical marshmallow 62. This view shows the following dimensions:
Mx: Marshmallow dimension in the minor axis
My: Marshmallow dimension in the major axis
Mz: Marshmallow dimension in the z-axis, or the height

An elliptical marshmallow could be sized and positioned in similar configurations to those shown in FIG. 4 and FIG. 8.

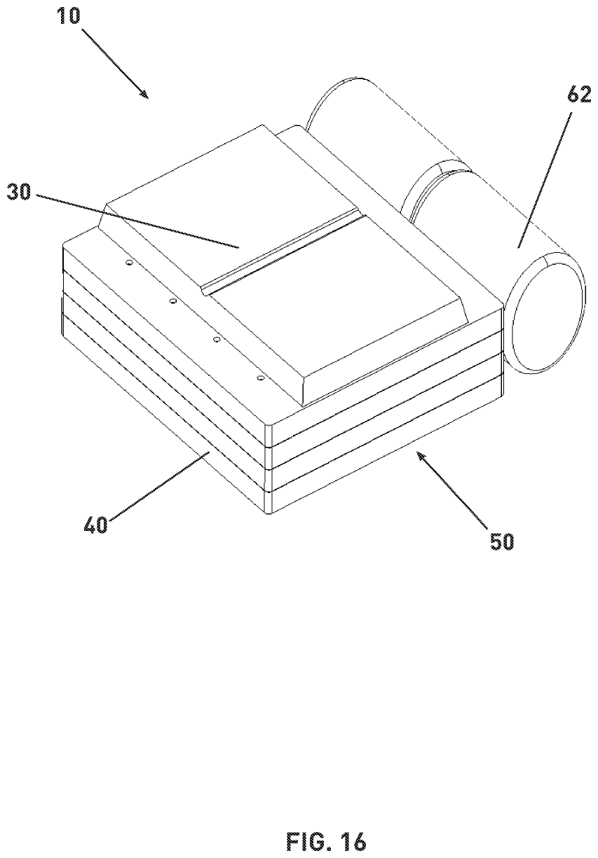

FIG. 16 is a perspective view of an alternate embodiment of the confectionery assembly 10 constructed in accordance with the invention and arranged as shown. The confectionery assembly 10 features two or more elliptical marshmallows 62 placed along either the width face 42 or length face 44 of one or more—preferably four—graham crackers 40 arranged into a stack of crackers 50, and one or more chocolate bars 30 resting above, below, or in the middle of the stack 50.

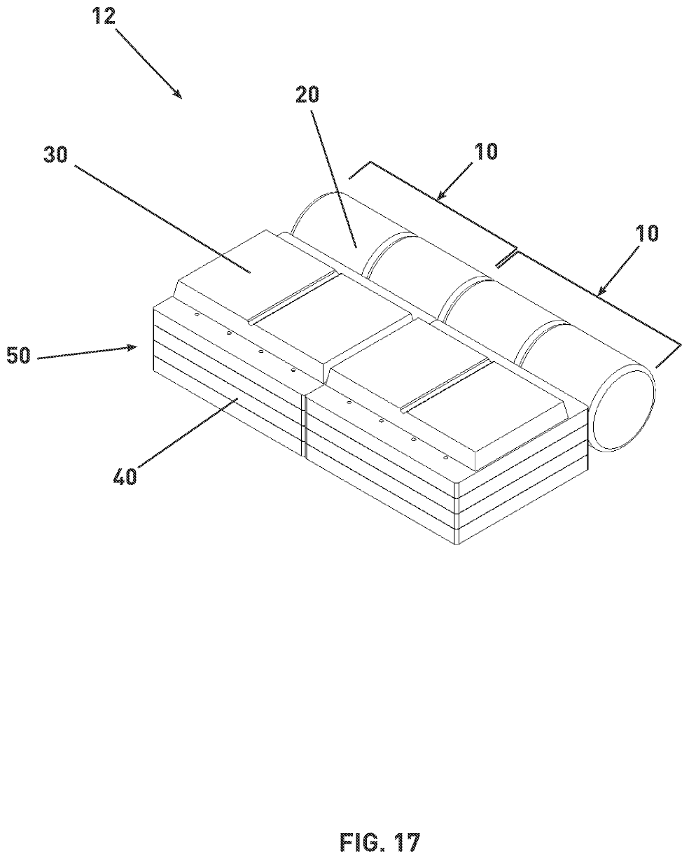

FIG. 17 is a perspective view of a multiple confectionery assembly 12. The multiple confectionery assembly 12 is comprised of two or more of the confectionery assemblies 10 using generally cylindrical marshmallows 20 shown in FIG. 1 or FIG. 8. Alternately, a multiple confectionery assembly 12 could be constructed using the confectionary assembly 10 shown using rectilinear marshmallows (FIG. 12), elliptical marshmallows (FIG. 16), or other shaped marshmallows.

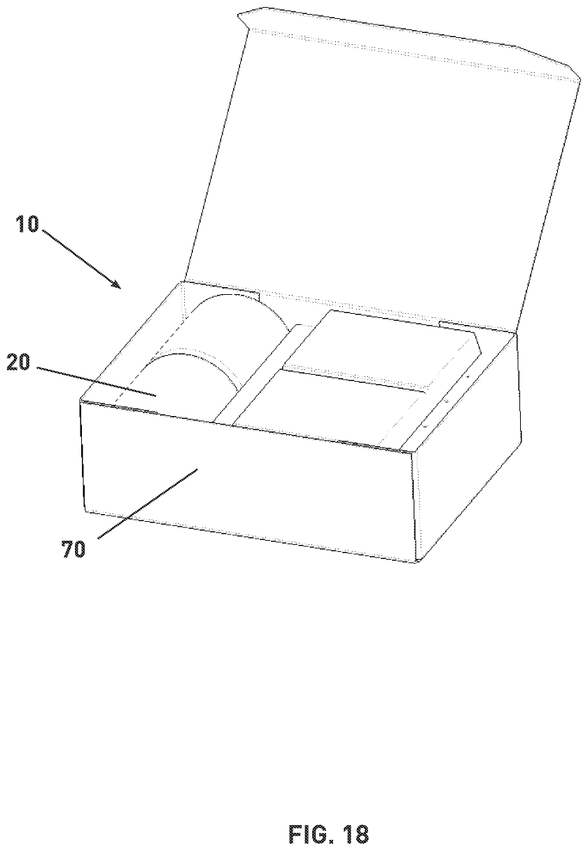

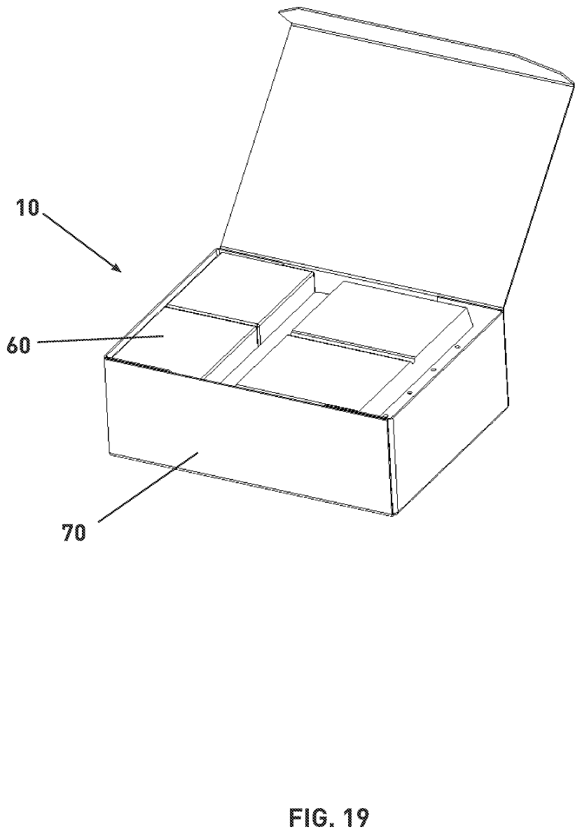

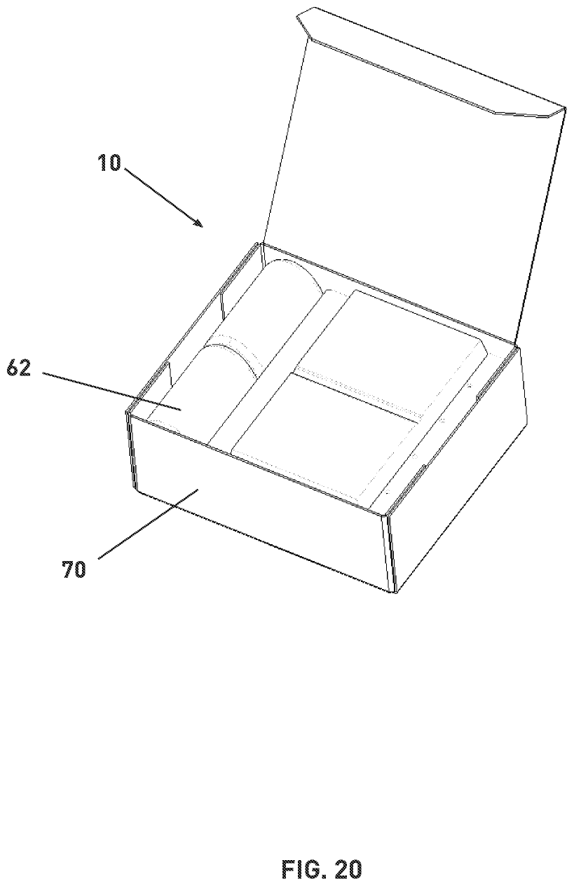

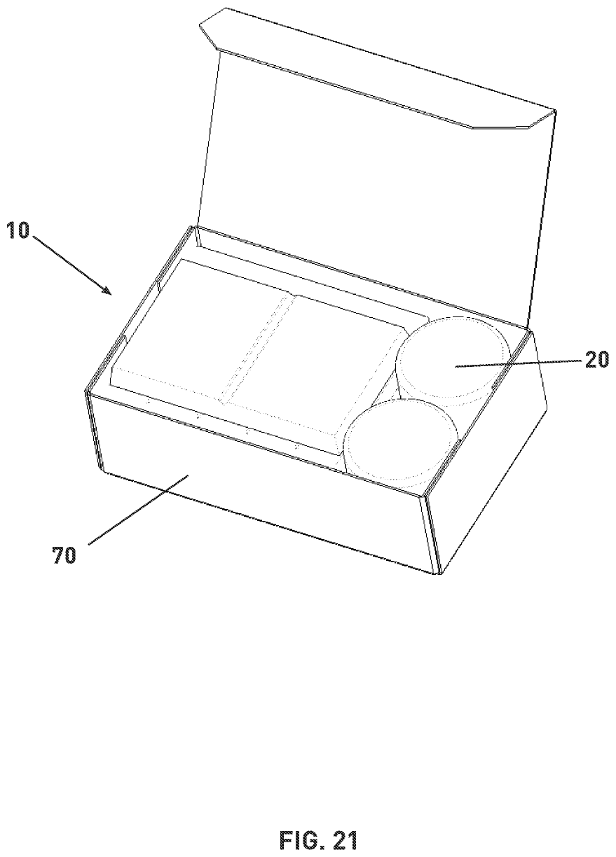

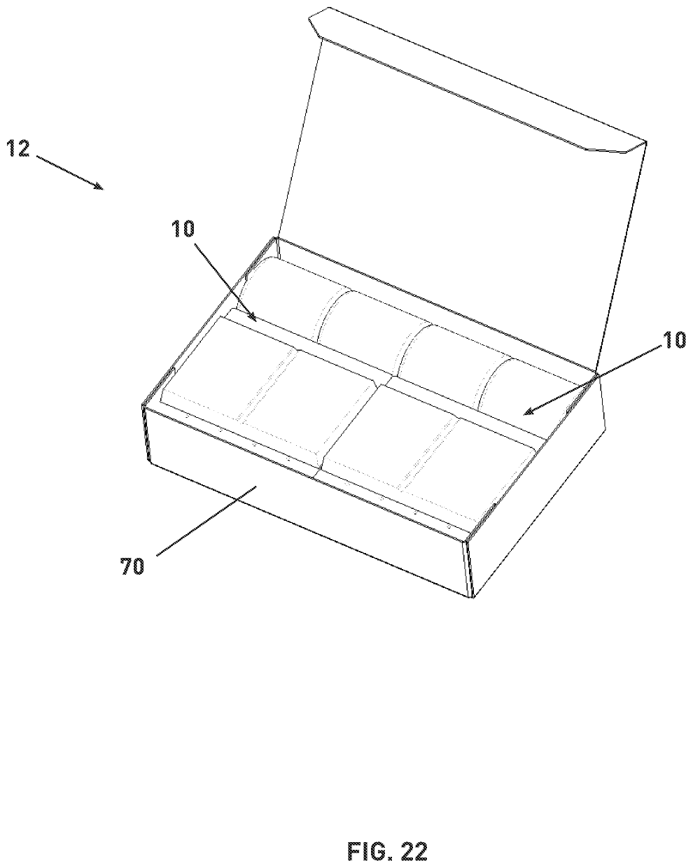

FIGS. 18-22 are perspective view of the confectionery assemblies of FIGS. 4, 12, 16, 8 and 17 respectively packaged in containing boxes 70 that are sized appropriately for compactly holding the respective confectionery assemblies.

Although only a few embodiments of the invention have been described in detail, the invention may be implemented in many other forms without departing from the spirit or scope of the invention. For example, in the various embodiments, the marshmallows within a particular confectionery assembly are oriented the same and have the same geometry. It should be apparent that in other embodiments, these characteristics may be mixed and matched as desired for aesthetic or other reasons. For example, one marshmallow may be stood on its end, while an adjacent marshmallow may rest on its side. In either a lateral or longitudinal orientation; or adjacent marshmallows may be laid on their sides in different orientations (e.g., laterally and longitudinally respectively). In another example, marshmallows having different geometries may be provided. For example, one marshmallow may have a cylindrical geometry while its neighbor may have a rectilinear or elliptical geometry. Of course, a variety of other combinations may be used as well.

Similarly, in embodiments that utilize multiple cracker stacks, the placement of the marshmallows relative to the stacks may be varied as well. For example, the embodiment of FIGS. 17/22 shows the marshmallows laterally arranged in a row laterally to the side of the cracker stacks. In other embodiments, the marshmallow may be positioned at one or both ends of the stacks, or in between the stacks. For example, two marshmallows could be placed at each end of the illustrated stack instead of laterally to the side of the stack as shown in FIGS. 17/22, or a 2/2 array of marshmallows could be placed at one end of the stack or between the stacks. Of course, other combinations may be used as well. Therefore, the present embodiments should be considered illustrative and not restrictive and the invention is not to be limited to the details given herein, but may be modified within the scope and equivalents of the appended claims. The described confectionery assembly has a number of advantages relative to traditional methods of assembly and transporting s'mores. The described s'more assembly is more convenient, eliminates the need to purchase larger quantities of individual components, and is a compact form factor for easy and convenient packing and transport. The sizing of the components creates a small and efficient overall package and helps protect the contents from damage during transport.

### REFERENCE NUMERALS

| | |
|---|---|
| 10 | Confectionery assembly |
| 12 | Multiple confectionery assemblies |
| 20 | Cylindrical marshmallow |
| 22 | Rounded surface |
| 24 | Flat end |
| 30 | Chocolate bar |
| 32 | Fracture feature |
| 40 | Graham cracker or biscuit |
| 42 | Width face |
| 44 | Length face |
| 50 | Stack of crackers |
| 60 | Rectilinear marshmallow |
| 62 | Elliptical marshmallow |
| 70 | Containing box |

1. A confectionary kit comprising:
a box that holds two marshmallows positioned side-by-side, and a stack that contains four crackers or biscuits and one or more chocolate pieces, the marshmallows being positioned at a first end of the stack within the box; and
wherein a width of the box is substantially similar to both a first dimension of the stack and a first dimension of the two side-by-side marshmallows, a length of the box is substantially similar to a sum of a second dimension of the stack and a second dimension of the marshmallows, and a height that is substantially similar to at least one of a height of the stack and a third dimension of the marshmallows.

2. A confectionary kit as recited in claim 1 consisting essentially of the box, the two marshmallows, the four crackers or biscuits and the one or more chocolate pieces.

3. A confectionary kit as recited in claim 1 wherein the crackers or biscuits are graham crackers.

4. A confectionary kit as recited in claim 1 wherein a single chocolate piece is provided and the chocolate piece has an integral fracture feature that facilitates readily breaking the chocolate piece into two.

5. A confectionary kit as recited in claim 1 wherein the marshmallows and the stack substantially fill the box.

6. A confectionary kit comprising a box that contains:
one or more stacks, each stack containing four crackers or biscuits and one or more chocolate pieces, the stacks being positioned side by side within the box; and
a plurality of marshmallows, there being two marshmallows for each stack, the marshmallows being positioned laterally adjacent the one or more stacks at a first end of the one or more stacks within the box; and
wherein a height of the box is substantially similar to at least one of a height of the stacks or a first dimension of the marshmallows and a second dimension of the box is substantially the same as the side by side stacks.

7. A confectionary kit as recited in claim 6 consisting essentially of the box, the marshmallows and the stacks, and wherein the stacks each consist of a plurality of crackers or biscuits and the one or more chocolate pieces.

8. A confectionary kit as recited in claim 6 wherein the crackers or biscuits are graham crackers.

9. A confectionary kit as recited in claim 6 wherein a single chocolate piece is provided in each stack and the chocolate piece has an integral fracture feature that facilitates readily breaking the chocolate piece into two.

10. A confectionary kit as recited in claim 6 wherein the marshmallows and stacks substantially fill the box.
